(19) United States
(12) Patent Application Publication
(10) Pub. No.: US 2025/0379375 A1
(43) Pub. Date: Dec. 11, 2025

(54) ELECTRICAL CONNECTION TERMINAL

(71) Applicant: WAGO Verwaltungsgesellschaft mbH, Minden (DE)

(72) Inventors: Sergej ZIER, Loehne (DE); Sergej ISAAK, Stedesdorf (DE); Michael KOHLSTAEDT, Porta Westfalica (DE); Rudolf MASTEL, Minden (DE); Marcel LIEBSCHER, Bad Salzuflen (DE); Thomas Ranis, Minden (DE)

(73) Assignee: WAGO Verwaltungsgesellschaft mbH, Minden (DE)

(21) Appl. No.: 19/183,387

(22) Filed: Apr. 18, 2025

(30) Foreign Application Priority Data
Apr. 18, 2024 (DE) 20 2024 101 937.7

(51) Int. Cl. H01R 4/50

(52) U.S. Cl. CPC H01R 4/5008

(57) ABSTRACT

An electrical connection terminal for the clamping contact of an electrical conductor, comprising a busbar with a side wall on which an abutment wall and a contact wall spaced apart therefrom are integrally formed with formation of a conductor connection channel that is accessible via an insertion opening. A clamping spring is provided with a contact leg that is contacted at the abutment wall of the busbar, and with a clamping leg that is connected to the contact leg. A clamping edge is guided against the contact wall of the busbar with formation of a clamping point.

This nonprovisional application claims priority under 35 U.S.C. § 119(a) to German Patent Application No. 20 2024 101 937.7, which was filed in Germany on Apr. 18, 2024, and which is herein incorporated by reference.

### BACKGROUND OF THE INVENTION

### Field of the Invention

The invention relates to an electrical connection terminal for the clamping contact of an electrical conductor, comprising a busbar that forms a conductor connection channel, and a clamping spring accommodated therein with a clamping leg that is connected to a contact leg via a spring bend.

### Description of the Background Art

A conductor connection terminal with a busbar portion and a clamping spring known from DE 10 2016 111 627 A1, which corresponds to US 2019/0131724, which is incorporated herein by reference, and which includes a clamping leg oriented toward the busbar portion with formation of a clamping point for connecting an electrical conductor, and a spring bend adjoining the clamping leg, as well as a contact leg which with a vertical section extends transversely to the busbar portion. The vertical section has a recess whose border edges encompass the busbar portion. An abutment wall adjoining the busbar portion is designed to support the vertical section of the contact leg of the clamping spring.

A conductor connection contact element that is preferably provided for direct circuit board contacting, having a busbar portion and having a clamping spring for connecting an electrical conductor, is known from DE 10 2015 017 151 A1, which is incorporated herein by reference. The busbar portion is formed from a sheet metal part with two oppositely situated side walls, thus forming a conductor insertion channel, and with a base section as well as an oppositely situated cover section. A conductor guide region adjoining a clamping section of the clamping spring and formed at a first side wall of the busbar portion is a section of the first side wall, which is obliquely oriented in the direction of the oppositely situated side wall.

### SUMMARY OF THE INVENTION

It is therefore an object of the invention to provide a particularly suitable electrical connection terminal. In particular, the aim is to provide a connection terminal that is as compact as possible.

The electrical connection terminal provided and configured for the clamping contact of an electrical conductor has a busbar with a side wall, an abutment wall, and a contact wall. The abutment wall and the contact wall are spaced apart from one another, preferably extending in parallel to one another. The preferably single side wall of the busbar is connected to the abutment wall and to the contact wall. The busbar is particularly preferably U-shaped, with the abutment wall and the contact wall forming the U legs, and the side wall forming the connecting leg for the U shape.

The height of the side wall of the busbar can be suitably greater than the width of the contact wall. The height of the side wall is preferably less than 2.5 times the width of the contact wall. The width of the contact wall is advantageously between 50% and 80%, in particular between 60% and 75%, of the width of the abutment wall. The width of the contact wall of the busbar can be between 40% and 60%, in particular 50±5%, of the height of the side wall. The width of the abutment wall of the busbar is suitably between 50% and 80%, in particular 70±5%, of the height of the side wall.

The busbar can be suitably formed from a sheet metal part, in particular as or in the manner of a stamped/bent part. The busbar particularly advantageously forms a spring cage, in particular for a contact spring or clamping spring. The busbar forms a conductor connection channel, also referred to as a (conductor) connection tunnel, that is accessible via an insertion opening, or provides such a channel.

The electrical connection terminal can have a clamping spring with a contact leg and a clamping leg. The contact leg can be connected to the clamping leg of the clamping spring via a spring bend. The clamping spring is preferably bent in an approximate U or V shape. The clamping leg at its free end has a clamping edge. The clamping spring is suitably accommodated, at least in part, in sections, or in regions, in the conductor connection channel of the busbar. In particular, at least the clamping edge of the clamping spring is situated in the conductor connection channel or tunnel of the busbar. The clamping spring is preferably braced in the busbar, between the abutment wall and the contact wall. The contact leg rests, preferably with as much of its surface as possible, against the abutment wall of the busbar.

A clamping spring can be understood to mean exactly one clamping spring or a plurality of clamping springs. The clamping spring is suitable for clamping the electrical conductor. The clamping spring is advantageously made of a spring steel and bent. The clamping spring advantageously can have exactly one clamping leg for clamping an associated electrical conductor, so that the same conductor is not clamped by two or more clamping legs of the clamping spring. The contact leg and the adjoining spring bend, as well as the clamping leg adjoining same, are suitably formed as one part.

The contact leg of the clamping spring can be designed to rest against a stationary area of the connection terminal in order to absorb the reactive elastic force (restoring force). The contact leg preferably rests only against the busbar, in particular against its abutment wall. The connection that is formed or provided by the clamping spring and the busbar suitably has a self-supporting design. The contact leg is advantageously directly connected to the clamping leg.

The clamping leg can extend within the conductor connection channel to the contact wall of the busbar. The clamping leg particularly preferably has a bending point or a right-angle bend with formation of two leg sections with different slopes. The clamping leg at its free end has a clamping edge that is guided against the contact wall of the busbar, with formation of a clamping point for clamping contact of the conductor that is guided through the insertion opening and into the (conductor) connection channel.

The length of the contact leg is suitably greater than the length of the clamping leg of the clamping spring. The length of the clamping leg of the clamping spring is preferably between 50% and 90%, in particular between 55% and 85%, preferably between 60% and 80%, particularly preferably 70±5%, of the length of the contact leg.

The spring bend of the clamping spring advantageously projects beyond the contact leg on its side opposite from the clamping leg. In other words, a curved section of the spring bend that adjoins the contact leg or merges into the contact leg projects beyond the contact leg on its (bottom) side opposite from the clamping leg.

The spring bend of the clamping spring can project beyond the busbar at the insertion opening. In particular, the spring bend projects beyond the abutment wall of the busbar. In other words, a curved section of the spring bend that merges into the contact leg projects beyond the abutment wall of the busbar. The abutment wall of the busbar particularly advantageously has a cutaway in which the spring bend or a curved section lies. Additionally or alternatively, the spring bend or a curved section of the spring bend projects beyond the side wall and/or the contact wall of the busbar at the insertion opening in the conductor connection channel of the busbar.

In an example of the clamping spring, its clamping leg can have an actuation section. The actuation section is used to actuate the clamping leg, for example, via a lever, a pusher, or an actuating tool. The actuation section protrudes beyond the clamping edge, particularly preferably at least in the (conductor) insertion direction. In particular, the actuation section projects beyond the clamping edge in a transverse direction with respect to the conductor insertion direction. The actuation section can project beyond the clamping edge in the conductor insertion direction and also in the transverse direction with respect to the insertion direction, parallel to the abutment wall and/or contact wall of the busbar.

The actuation section can be oriented toward the contact leg of the clamping spring. The actuation section can have an arched design, in particular oriented on the arch end side toward the contact leg of the clamping spring. This provides particularly suitable actuation of the contact leg for the purpose of deflecting the clamping spring with opening up of the contact point, in particular in order to reliably insert the conductor into the contact point. In addition, it is advantageously made possible for an actuating element, in particular a swivel lever, also referred to below as a lever, to be brought into contact with the actuation section adjacent to the contact edge (spatially next to the contact edge) of the contact leg or along the contact edge.

The contact wall of the busbar can have a smaller width than the abutment wall, or can have a cutaway. The actuation section of the clamping leg of the clamping spring is accessible in a direction normal or perpendicular to the plane of the contact wall (transverse direction with respect to the conductor insertion direction) via the cutaway or due to the smaller width of the contact wall of the busbar. In other words, the actuation section of the clamping leg is accessible in the direction of or perpendicular to the clamping edge. A particularly compact design of the connection terminal is thus advantageously made possible.

A recess, also referred to below as a cutaway (spring cutout), can be provided in the contact leg of the clamping spring. A recess, also referred to below as a cutaway (bar cutout), is particularly advantageously introduced into the abutment wall of the busbar. The spring cutout and the bar cutout are advantageously in flush alignment with one another. The spring cutout and the bar cutout suitably overlap, at least in part or almost completely.

The cutaway position of the spring cutout or the position of the cutaway design formed from the spring cutout and the bar cutout is advantageously adapted to the position of the contact leg of the clamping spring, which is deflected or swiveled in toward the contact leg, in such a way that when the clamping spring is tensioned or the clamping leg is swiveled, the free end of its leg, in particular the actuation section of the clamping leg, can immerge into the spring cutout or into the spring cutout and the bar cutout. A particularly compact construction of the basic design of the connection terminal formed from the busbar and the contact spring is achieved in this way.

In other words, the installation height or the wall spacing between the contact wall and the abutment wall of the busbar may have a particularly small design or may be minimized by means of this cutaway design. In addition, or for the same overall height of the conductor connection channel, a correspondingly larger space is advantageously provided within the conductor connection channel for the conductor, for example a stranded conductor. A conductor cross section having a corresponding size may also be connected or contacted by clamping.

In an example of the electrical connection terminal, in particular of the basic design of the connection terminal that is formed from the busbar and the contact spring, at least one form fit or form-fit connection (joint) can be provided between the clamping spring and the busbar. The at least one form fit is suitably formed from the material of the clamping spring and the busbar themselves, i.e., without an additional joining element.

In the present and subsequent discussions, a “form fit” or a “form-fit connection” between at least two interconnected parts can be understood in particular to mean that the holding together of the interconnected parts takes place at least in one direction via direct interlocking of contours of the parts themselves. In other words, the “blocking” of mutual movement in this direction is based on the shape.

A joint protrusion can be integrally formed on the contact leg of the clamping spring, in particular oriented transversely to the conductor insertion direction. A (corresponding) joint opening in which the joint protrusion on the clamping spring side can be accommodated is advantageously provided in the busbar. The joint opening on the bar side is suitably provided in or at the transition between the abutment wall and the side wall, in particular in a bending area between the side wall and the abutment wall.

A joint opening with a constriction can be provided in the busbar. In particular, an abutment contour that acts only locally and/or as a punctiform abutment at the joint protrusion of the contact leg of the clamping spring is provided. This abutment contour is suitably formed by an undulating shape of the opening edge of the joint opening on the bar side, facing the joint protrusion on the spring side. The joint protrusion of the contact leg of the clamping spring suitably lies in the joint opening of the busbar, in particular in a form-fit and/or force-fit manner.

A support bracket or clamping bracket, also referred to below as a support protrusion, with a (bracket) free end directed or guided toward the abutment wall of the busbar, can be integrally formed on the contact wall of the busbar. In particular, the support bracket can be provided at the bar end opposite from the insertion opening or at a narrow side or end-face side of the busbar facing away from the insertion opening in the conductor insertion direction. A joint gap is formed between the support bracket or its free end and the abutment wall of the busbar, and the contact leg of the clamping spring lies in the joint gap in areas or with a leg section and/or is fixed by clamping.

A joint protrusion that is oriented/guided toward the contact wall of the busbar can be integrally formed on the abutment wall of the busbar, in particular at the bar end opposite from the insertion opening. The joint protrusion suitably has a joint contour that corresponds to a joining element of the support bracket, in particular with establishment of a form fit or a form-fit connection. The joint protrusion may also have a joint contour with which a joining element of the support bracket engages in a form-fit manner. In addition, a joint pin that is made, in particular formed, from the side wall of the busbar may also be accommodated in the joint opening. Alternatively, a joint pin that is made, in particular formed, from a connection contact (fork contact or blade contact), in particular at the bar end situated opposite from the insertion opening, and integrally formed on the busbar or connected thereto, may be accommodated in the joint opening.

This joint design, which also represents an independent invention, is based on the consideration that spaced-apart, oppositely situated bar walls or bar sections of the busbar that form a spring cage are to be suitably connected in order to withstand the elastic forces of the clamping spring, which is braced in particular between these bar sections or bar walls, or to absorb these elastic forces while maintaining the dimensional stability of the busbar. For this purpose, the joint may be designed, for example, in the manner of a puzzle part or dovetail joint, or also some other connection of opposite joint contours.

The joint design also allows other or additional functions, in particular a suitable hold-down element of the contact leg of the clamping spring and/or a locking functionality, for example to ensure consistent positioning and/or uniform contact forces in contact legs (“tulip legs”) of a fork contact on a plug contact side of the busbar opposite from the conductor insertion opening.

A positioning protrusion that protrudes into the spring bend of the clamping spring, preferably with abutment against the spring bend and/or the contact leg, can be integrally formed on the busbar, in particular at the side wall, preferably in the region of the (conductor) insertion opening. Particularly advantageous fixing of the position (spring position) or the location (location fixing) of the clamping spring within the conductor connection channel is thus achieved.

An actuating element for swiveling the clamping leg of the clamping spring, preferably in a transverse direction with respect to the conductor insertion direction, oriented toward the contact leg of the clamping spring, in particular against the elastic force of the clamping spring, can be provided. The actuating element may be actuated manually or by means of an actuation tool, for example, and has a corresponding design.

The connection terminal suitably has a bearing and a counterbearing for supporting the actuating element for a swivel movement. The counterbearing for the actuating element can be provided in a housing (insulation housing, clamping housing) and/or in the busbar, for example. A rotational axis of the actuating element suitably extends in parallel to the contact wall and outside the conductor connection channel, in particular on the side of the contact wall opposite from the clamping point, and in the transverse direction with respect to the conductor insertion direction, in other words, transversely to the direction of insertion of the conductor into the connection channel formed by the busbar.

In an example of an electrical connection terminal for the clamping contact of an electrical conductor, in particular which also represents an independent invention, has a busbar with a side wall on which an abutment wall and a contact wall, spaced apart therefrom and preferably extending in parallel, are integrally formed with formation of a conductor connection channel that is accessible via an insertion opening. The connection terminal has a clamping spring, in particular situated in the conductor connection channel, with a contact leg that is contacted at the abutment wall of the busbar, and with a clamping leg, connected thereto via a spring bend, with a clamping edge that is guided against the contact wall of the busbar with formation of a clamping point, in particular for the clamping contact of the conductor that is inserted in an insertion direction into the conductor connection channel via the insertion opening, between the clamping spring and the busbar.

The electrical connection terminal can have an actuating element for swiveling the clamping leg against the elastic force of the clamping spring in the direction of its contact leg. The actuating element can be supported so that it is pivotable about a rotational axis that is provided outside the busbar, in particular above the contact wall or on its side facing away from the contact point. The actuating element is suitably introducible into the conductor connection channel via a cutaway of the contact wall of the busbar. The cutaway may extend over the entire length of the contact wall in the conductor insertion direction. In other words, the width of the contact wall may be smaller than the width of the abutment wall.

The actuating element can be coupleable to an actuation section of the clamping leg that protrudes beyond the clamping edge and/or that is placeable against this actuation section. In particular, the actuating element has a preferably rounded end-face side (actuation edge), which in the course of actuating the actuating element rests against the actuation section of the clamping leg of the clamping spring, preferably in a sliding or rolling manner.

The actuating element can have a base body with integrally formed bearing pins, one on each side. According to one practical refinement, which in particular also represents an independent invention, mutually coaxial bearing pins having different axial lengths and/or various pin diameters are integrally formed on the actuating element.

The actuating element suitably has an in particular centerboard-like eccentric section extending radially with respect to the rotational axis. The actuating element particularly advantageously has a base body with an axial cutaway with formation of an in particular rounded or arched swivel contour. The actuating element particularly advantageously has an in particular manually operable lever section extending radially with respect to the rotational axis.

The electrical connection terminal for the clamping contact of an electrical conductor, which in particular also represents an independent invention, can have a busbar with a side wall on which an abutment wall and a contact wall spaced apart therefrom are integrally formed with formation of a conductor connection channel that is accessible via an insertion opening. A clamping spring, which can be situated at least partially in the conductor connection channel, has a contact leg that is contacted at the abutment wall of the busbar, and a clamping leg, connected thereto via a spring bend. The clamping leg has a clamping edge that is guided against the contact wall of the busbar with formation of a clamping point. The clamping edge is used for the clamping contact of the conductor that is inserted into the conductor connection channel in an insertion direction via the insertion opening, between the clamping spring and the busbar.

The electrical connection terminal can have a contact (connection contact) that is provided, in particular integrally formed, on the end of the busbar opposite from the insertion opening. The contact may be a blade contact. The (connection) contact can be a fork contact with a contact leg, also referred to below as a tulip leg or fork leg, which is oriented along the insertion direction and which forms a contact point, in particular for a contact pin. In the area of their movable free ends, the contact legs suitably have mutually facing curvatures, in particular produced by bead-like embossment, which form the contact point or between which the contact point is formed.

The electrical connection terminal can have a two-part clamping housing whose housing parts are locked to the preferably U-shaped busbar.

The housing parts suitably can have joining elements or detent contours that correspond to the busbar. A first housing part that accommodates the busbar, in particular with the clamping spring already situated therein, advantageously has a first joining element or a first detent contour, while the abutment wall of the busbar has a corresponding detent contour or a corresponding joining element. A second housing part that accommodates, for example, a connection contact or the fork contact particularly advantageously has a first joining element or a first detent contour, while the contact wall of the busbar has a corresponding detent contour or a corresponding joining element.

The clamping housing or its housing parts can be made of an insulation material, in particular a plastic. In an area opposite from the side wall of the busbar, the conductor connection channel can be closed via a side wall of the clamping housing or insulation housing, in particular its housing part. In other words, a side wall of the clamping housing or insulation housing forms a wall that circumferentially closes the conductor connection channel or forms a missing side wall of the busbar.

The clamping housing, in particular its first housing part, can have a free area. The actuating element, in particular its eccentric section, passes through this free area. In other words, the actuating element, in particular its eccentric section, immerges into the free area of the clamping housing, and via same into the conductor connection channel. Additionally or alternatively, the actuating element actuates the clamping spring or its clamping leg only in an area opposite from the side wall of the busbar.

A side wall of the clamping housing and an actuating element can form a channel wall that circumferentially closes the conductor connection channel. The side wall of the clamping housing and an actuating element, in particular its eccentric section, are preferably in flush alignment with one another, in particular within the scope of manufacturing tolerances.

A side wall of the clamping housing and an actuating element (eccentric section) in flush alignment with the side wall may form a channel wall that circumferentially closes the conductor connection channel. The clamping housing, in particular its first housing part, an have an entry channel for the conductor. In particular, the entry channel is funnel-shaped or has a design that conically tapers toward the conductor connection channel.

The insertion area for the conductor, via the entry channel and into the conductor connection channel of the connection terminal, is particularly advantageously free of edges or other barriers (impact areas), so that the conductor may be guided to the contact point unhindered. A recess on the housing side for the spring bend or a curved section of the spring bend of the clamping spring can be provided in a channel area of the entry channel of the clamping housing which opens into the conductor insertion channel.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a side view of an electrical connection terminal, with a busbar that forms a connection channel for an electrical conductor (conductor connection channel), and with a clamping spring accommodated therein,

FIG. 2 shows a perspective illustration of an electrical connection terminal, with a busbar that forms a connection channel for an electrical conductor (conductor connection channel or tunnel), and with a clamping spring accommodated therein, and a fork contact,

FIG. 3 shows a side view of an electrical connection terminal, with a busbar that forms a connection channel for an electrical conductor (conductor connection channel), and with a clamping spring accommodated therein, and a swivel lever, as an actuating element, that actuates the clamping spring,

FIG. 4 shows a perspective illustration of an electrical connection terminal, with a busbar that forms a connection channel for an electrical conductor (conductor connection channel), with a view of a side wall having a joint opening and a joint protrusion, lying therein, of a clamping spring that is accommodated in the conductor connection channel,

FIG. 5 shows a perspective illustration of an electrical connection terminal, with a busbar and with a clamping spring, accommodated therein, having a cutaway in a contact leg,

FIG. 6 shows a side view of an electrical connection terminal, with a busbar that forms a connection channel for an electrical conductor (conductor connection channel), and with a clamping spring, accommodated therein, having a spring bend, and a positioning protrusion of the busbar that is inserted therein,

FIG. 7 shows a perspective illustration of a portion of an electrical connection terminal with a busbar, with a view of a side wall having a joint protrusion lying in a joint opening, and having a positioning protrusion of the busbar lying in a spring bend of a clamping spring,

FIG. 8 shows a perspective illustration of a portion of an electrical connection terminal, with a busbar having a contact leg of the clamping spring lying (in areas or in sections) in a joint gap between an abutment wall and a support bracket of the busbar,

FIG. 9 shows a perspective illustration of a portion of an electrical connection terminal, with a busbar having a clamping spring situated therein, with a cutaway in a contact leg, and with a corresponding cutaway in an abutment wall of the busbar,

FIG. 10 shows a side view of an electrical connection terminal, with a busbar that forms a connection channel for an electrical conductor (conductor connection channel), and with a clamping spring, accommodated therein, having an actuation section, adjacent to a clamping edge of a contact leg, that is formed from same,

FIG. 11 shows a perspective illustration of an electrical connection terminal, with a busbar with a view of a cutaway in a contact wall as access for an actuating element to the clamping leg of a clamping spring that is situated, in particular braced, between the contact wall and an abutment wall of the busbar,

FIG. 12 shows a perspective illustration of an electrical connection terminal according to FIG. 11, with a lever that is swiveled in abutment with an actuation section as an actuating element,

FIG. 13 shows a perspective illustration of a housing of a series arrangement of electrical connection terminals, with actuation levers that are pivotably supported on the housing side,

FIG. 14 shows, in a sectional illustration along the line XIV-XIV in FIG. 13, a first variant of a first housing part that is locked to an abutment wall of the busbar, and of a second housing part that is locked to a contact wall of the busbar,

FIG. 15 shows, in an illustration according to FIG. 14, a second variant of a first housing part that is locked to an abutment wall of the busbar, and of a second housing part that is locked to a contact wall of the busbar, and

FIGS. 16A through 16D show a top view of an actuation lever having bearing pins that are integrally formed on both sides of a body, relative to a rotational axis, and that have different geometries or various dimensions (pin length, pin diameter).

### DETAILED DESCRIPTION

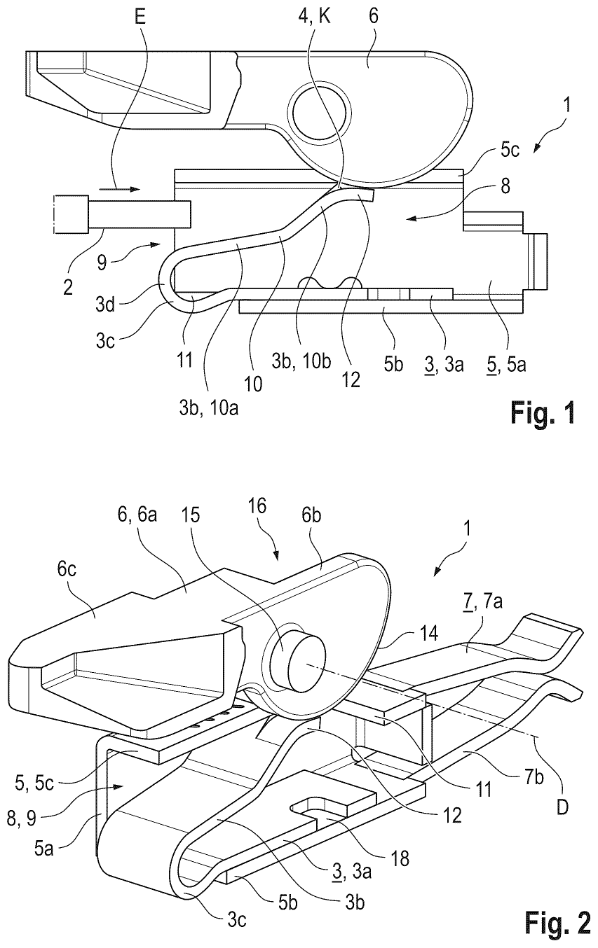

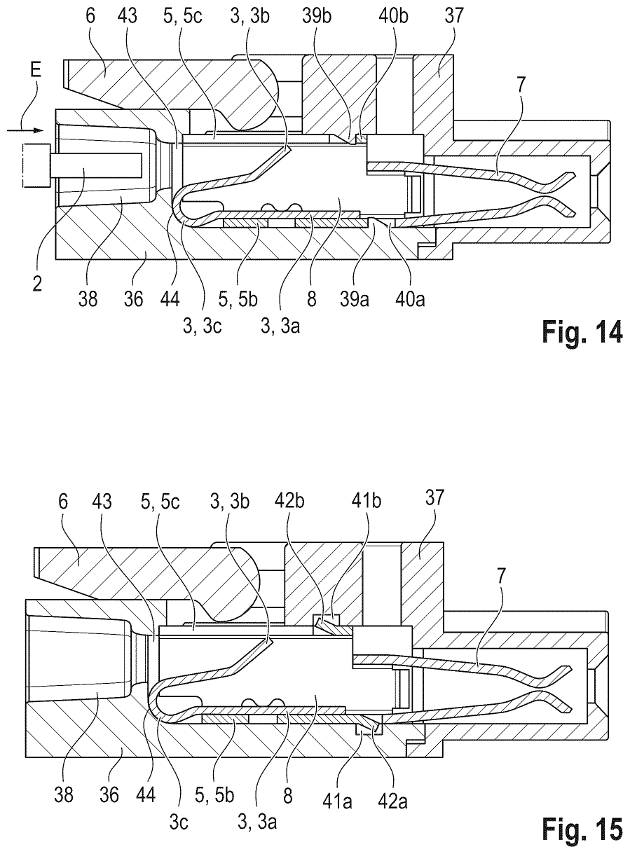

The electrical connection terminal 1 illustrated in the figures allows electrical connection of a conductor 2 (illustrated in FIGS. 1 and 14). In the present and subsequent discussions, a conductor is understood in particular to mean a (conductor) core of an (electrical) line that is formed from one or more wires made of an electrically conductive material, for example copper, and enclosed by a conductor sheath made of an insulation material.

For the electrical connection, the conductor 2 is clamped by a clamping spring 3. The elastic force of the clamping spring 3 has a clamping effect on the conductor 2. In particular, a free end (spring free end or leg free end) of the clamping spring 3 forms a clamping edge 4 that penetrates into the material of the conductor 2 (its conductor core) and thus significantly increases a withdrawal force.

The connection terminal 1 has a busbar 5 for electrically contacting the conductor 2. The busbar 5 is advantageously made of a material that has better current conductivity than the clamping spring 3. Accordingly, the conductor 2 is electrically connected to the busbar 5. The connection terminal 1 advantageously has an actuating element 6, preferably in the form of (swivel) lever, for actuating the clamping spring 3. The busbar 5 advantageously has a further electrical connection, for example a blade contact or a solder connection, for further electrical connection, or has a further connection terminal for connecting a further conductor. A fork contact 7, which is apparent in particular in FIGS. 2 through 5 and FIGS. 11 and 12, is preferably provided as the further electrical connection.

According to a basic design shown in FIG. 1, the electrical connection terminal which is provided and configured for the clamping contact of an electrical conductor 2 has the busbar 5 and the clamping spring 3. The busbar has a side wall 5a and an abutment wall, 5b, as well as a contact wall 5c. The abutment wall 5b is provided at an angle, in particular a right angle, with respect to the side wall 5a. In addition, the clamping wall 5c is bent at an angle, in particular a right angle, with respect to the side wall 5a. The abutment wall 5b and the contact wall 5c are spaced apart or extend at least approximately parallel to one another. The busbar 5 is U-shaped, and is preferably designed with exactly three walls 5a, 5b, 5c

The busbar 5 forms a conductor connection channel or a conductor connection tunnel 8, in which the conductor 2 is insertable into the connection terminal in an insertion direction E via an insertion opening 9. In addition, the abutment wall 5b of the busbar 5 particularly advantageously delimits the conductor connection channel (conductor connection tunnel) 8. The conductor 2 is thus also guided, through or by the abutment wall 5b of the busbar 5, in the rear channel section facing away from the insertion opening 9.

In particular in a U-shaped geometry, the busbar 5 has good conductivity or a low (electrical) resistance due to the high material content, even with a preferably compact design.

In one advantageous, particularly compact design of the connection terminal 1, the height of the side wall 5a (side wall height of the busbar 5) is less than 2.5 times the width of the contact wall 5c (contact wall width of the busbar 5).

The width of the contact wall 5c of the busbar 5, relative to the insertion direction E, is in particular between 60% and 75% of the width of the abutment wall 5b. The width of the contact wall 5c of the busbar 5 is in particular 50±5% of the height of the side wall 5a. The width of the abutment wall 5b is in particular 70±5% of the height of the side wall 5a of the busbar 5. The height of the side wall of the busbar is suitably 3 ±1 mm. This allows provision of a particularly compact connection terminal.

The clamping spring 3 has a contact leg 3a, and a clamping leg 3b, which via a spring bend 3c is connected in one part (in one piece) to the contact leg 3a or formed (by bending). The clamping spring 3 is curved in an approximate U shape. The length of the clamping leg 3b of the clamping spring 3 is in particular 70±5% of the length of the contact leg 3a. The length of the clamping leg 3b of the clamping spring 3 is preferably 5.5±1.5 mm.

The advantageously bent clamping leg 3b has the clamping edge 4 on the free end side. The clamping spring 3 is accommodated in the conductor connection channel 8 of the busbar 5, and preferably is braced between the abutment wall 5a and the contact wall 5b. The contact leg 3a of the clamping spring 3 rests against the abutment wall 5b of the busbar 5 with mechanical or electrical contact.

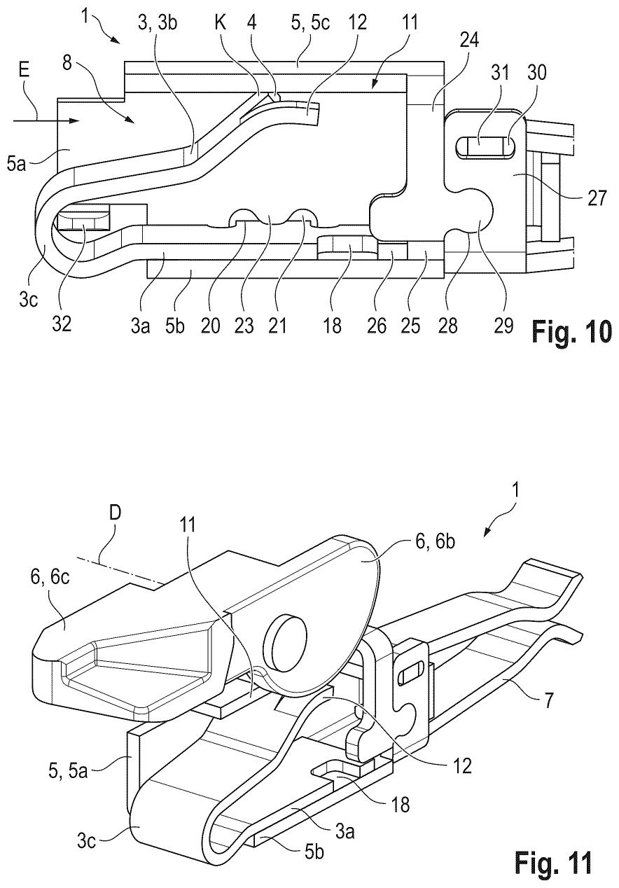

The clamping leg 3b of the clamping spring 3 extends within the conductor connection channel to the contact wall 5c of the busbar 5. The clamping leg 3b has a bending point or offset 10 with formation of a first leg section 10a that leads to the spring bend 3c, and a second leg section 10b that runs into the clamping edge 4, and that has a greater slope than the first leg section 10a. The clamping edge 4 at the free end of the clamping leg 3b together with the contact wall 5c of the busbar 5 forms a clamping point K (FIGS. 1 and 10) for the clamping contact of the conductor 2 that is guided into the conductor connection channel 8 via the insertion opening E.

The spring bend 3c of the clamping spring 3 projects beyond the busbar 5 at the insertion opening. A curved section of the spring bend 3c that merges into the contact leg 3a projects beyond the abutment wall 5b of the busbar 5. It is apparent that the spring bend 3c of the clamping spring 3 or a curved section of the spring bend 3c that merges into the contact leg 3a projects beyond the contact leg 3a on its bottom side facing the abutment wall 5 of the busbar 5.

The abutment wall 5b of the busbar 5 has a cutaway 11 in which the spring bend 3c or the curved section lies. The arch apex 3d of the spring bend 3c of the clamping spring 3 projects beyond the side wall 5a, and in the example shown also projects beyond the contact wall 5c of the busbar 5 at the insertion opening 9 of the conductor connection channel 8.

As is comparatively clearly apparent with regard to FIG. 2, the clamping leg 3b of the clamping spring 3 has an actuation section 12 for actuating the clamping leg 3b by means of the lever 6, which is rotationally or pivotably movable about a rotational axis D. The actuation section 12 projects beyond the clamping edge 4 or is spatially next to same on the edge side facing away from the side wall 5a of the busbar 5. The actuation section 12 projects beyond the clamping edge 4 axially in relation to the rotational axis D of the lever 6. The suitably arched actuation section 12 is oriented toward the contact leg 3a.

The busbar 5 has a cutaway 13 in its contact wall 5c via which the actuation section 12 is accessible. The lever 6 may thus be swiveled across the bar-side cutaway 13, and thus spatially next to the contact edge 4 of the contact leg 3b, in abutment with the actuation section 12 of the clamping leg 3b, in order to swivel the clamping leg 3b in the direction of the contact leg 3a, against the elastic force of the clamping spring 3. For this purpose, the lever 6 suitably has an eccentric section 6b which is integrally formed on a base body 6a, and which with a rounded or arched end-face side 14 extends radially with respect to the rotational axis D. When the lever 6 is actuated to tension the clamping spring 3 or to open the conductor clamping point K that is formed between the clamping edge 4 and the bottom side of the contact wall 5c of the busbar 5 facing the abutment wall 5b, this end-face side rests slidingly against the actuation section 12 of the clamping leg 3b. The lever 6 has a manually operable lever section 6c that extends radially with respect to the rotational axis D.

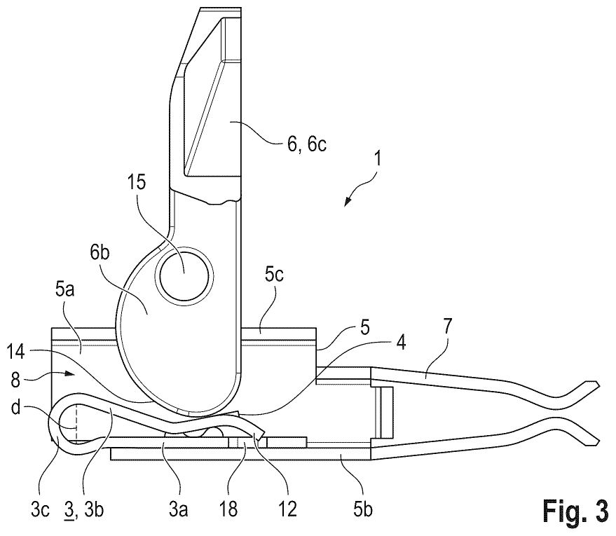

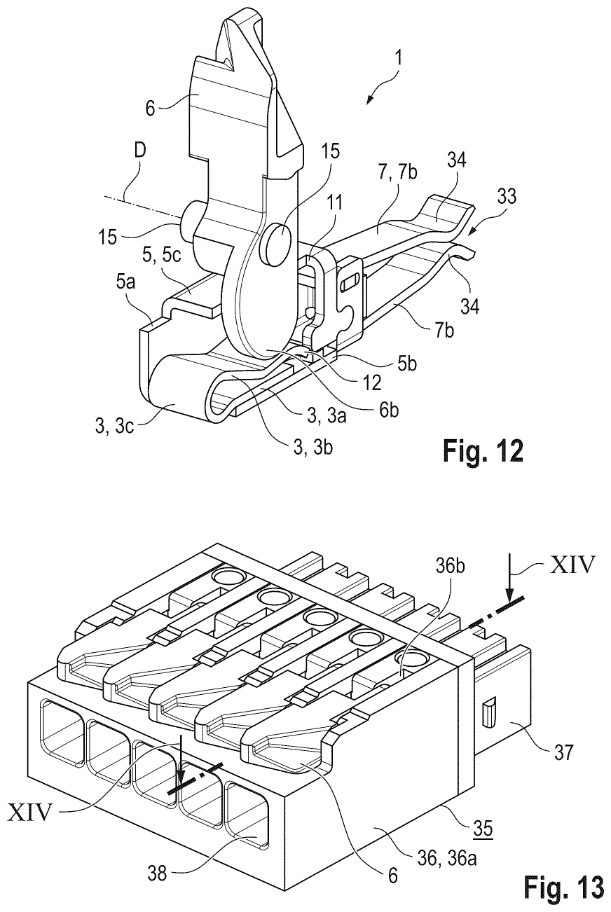

As is comparatively clearly apparent with regard to FIGS. 3, 4, and 12, a bearing pin 15 is integrally formed on each side of the base body 6a of the lever 6. The lever 6 or its base body 6a has a cutaway or a stepped recess 16, and a rounded or arched swivel contour 17 (FIG. 12). A quasi-disk-shaped eccentric section 6b of the lever 6 is formed or provided by the stepped recess 16. The lever 6 rests only with this eccentric section 6b against the clamping leg 3b or the actuation section 12 of the clamping spring 3 in order to tension them.

FIG. 3 shows the lever 6 in a so-called over-center point. In this state the lever 6 is no longer moved back into the starting state shown in FIG. 2, for example, by the restoring force of the clamping spring 3. The clamping point K therefore remains open until the lever 6 is (manually) moved out of the over-center point.

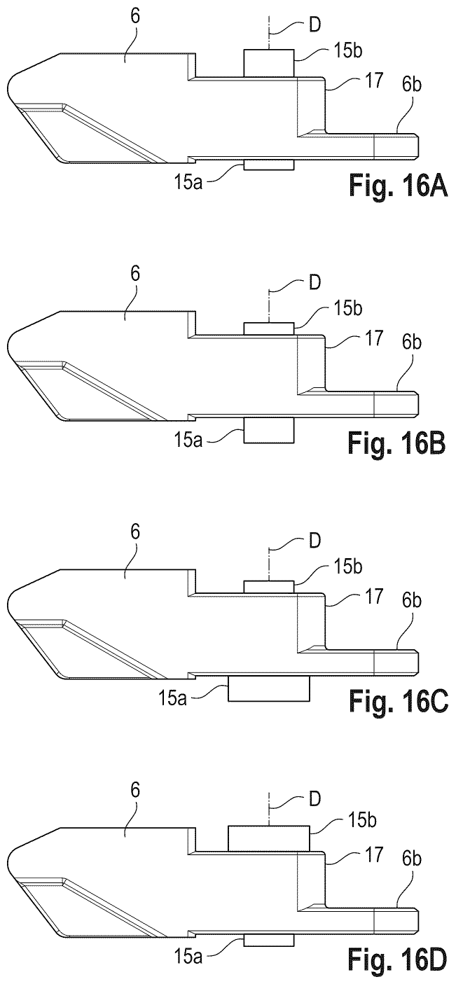

When the clamping spring 3 is tensioned, only the eccentric section 6b of the lever 6 presses against the clamping leg 3b. Based on a resulting one-sided load on the lever 6 or asymmetrical force transmission, the bearing pins 15 advantageously have a suitable geometric design (FIGS. 16A through 16D). In this position, in which the clamping point K is practically fully open, the clamping leg 3b contacts the contact leg 3a. In other words, in this position of the clamping leg 3c, between it and the contact leg 3a, there is essentially no gap, at least in places, or only a small gap or space that is present. This gap is preferably smaller than one-half the diameter d of the spring bend 3c. The diameter d of the spring bend 3c of the clamping spring 3 is between 0.5 mm and 1.5 mm.

As is apparent with regard to FIGS. 3, 5, and 6 and FIGS. 8 and 9, the contact leg 3a of the clamping spring 3 has a cutaway 18, also referred to below as a spring cutout, as a local recess. A cutaway 19, also referred to below as a bar cutout, is likewise particularly advantageously provided in the abutment wall 5b of the busbar 5 as a local recess. The bar cutout 19 is overlapped by the spring cutout 18 (FIG. 9).

As is apparent from FIG. 3, the cutaway position of the spring cutout 18 is adapted to the position of the contact leg 3b of the clamping spring 3 that is deflected or swiveled in toward the contact leg 3a, so that when the clamping spring 3 is tensioned and the clamping leg 3b is swiveled, its actuation section 12 immerges into the spring cutout 18 or into the spring cutout and the bar cutout 19. This allows a particularly compact construction of the basic design of the connection terminal 1 formed from the busbar 5 and the contact spring 3.

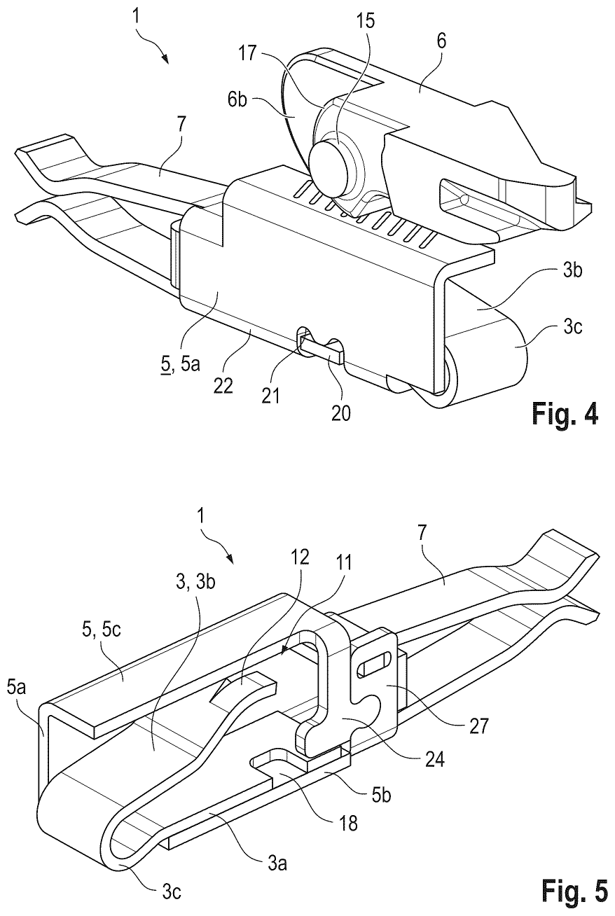

FIGS. 4 through 12 show, once again proceeding from the basic design of the electrical connection terminal 1 made up of the busbar 5 and the contact spring 3, examples with in particular form-fit joints provided between the clamping spring 3 and the busbar 5. The respective, in particular form-fit, connection is formed from the material of the clamping spring 3 and that of the busbar 5 itself.

FIG. 4 shows an example of the electrical connection terminal 1 in which a joint protrusion 20 that is oriented transversely to the conductor insertion direction 8, or axially with respect to the rotational axis D, is integrally formed on the contact leg 3a of the clamping spring 3. A (corresponding) joint opening 21 in which the joint protrusion 20 on the clamping spring side is accommodated is introduced into the busbar 5. The joint opening 21 on the bar side is introduced into a bending section 22 between the side wall 5a and the abutment wall 5b.

As is comparatively clearly apparent in FIG. 7, a joint opening 21 having a constriction 23 with formation of a local, in particular punctiform, abutment at the joint protrusion 20 of the contact leg 3a of the clamping spring 3 is provided in the busbar 5. The constriction 23 is formed by a wave crest of an undulated opening edge 21a of the bar-side joint opening 21 facing the joint protrusion 20.

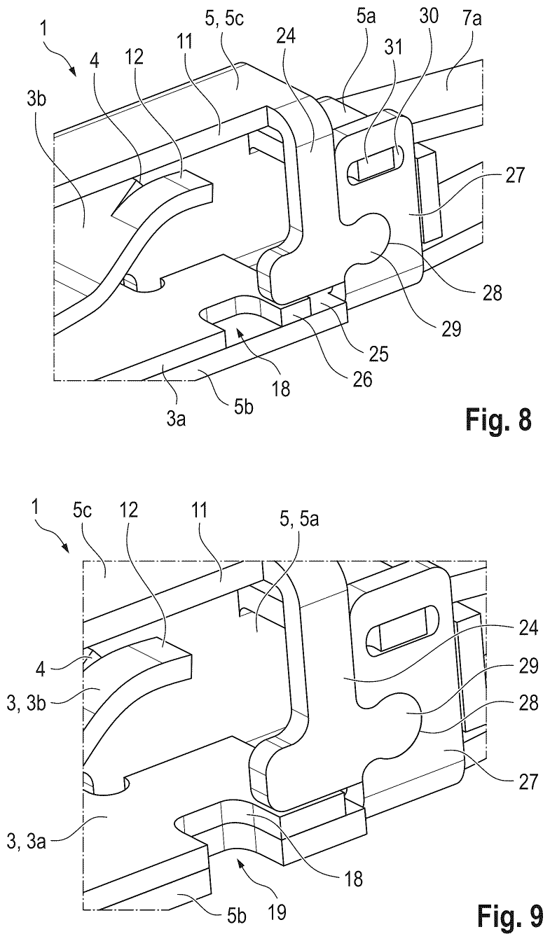

As is comparatively clearly apparent in FIGS. 8 through 10, a supporting bracket or clamping bracket 24 is provided at the contact wall 5c of the busbar. This bracket is integrally formed on the abutment wall 5b at the narrow side, in the (conductor) insertion direction E facing away from the insertion opening 9, or in the area of the end-face side of the busbar 5 opposite from the insertion opening E, or is formed from the abutment wall, in particular by stamping/bending. The supporting bracket or clamping bracket 24 is suitably bent extending in parallel with respect to the side wall 5a. The width of the supporting bracket or clamping bracket 24 in the area of its narrow bracket section, extending in the insertion direction E, is suitably approximately 10±1% of the width of the busbar 5.

A joint gap 25 is formed between the support bracket 24 or its free end and the abutment wall 5b of the busbar 5. The contact leg 3a of the clamping spring 3 lies in this joint gap, in areas or with a bar section or leg section 26, preferably in a form-fit manner and/or fixed by clamping.

According to one design of the connection terminal 1, a bracket-like joint protrusion 27 is integrally formed on the abutment wall 5b of the busbar 5, and is directed or guided toward the contact wall 5c of the busbar. This joint protrusion is situated at the bar end opposite from the insertion opening 9, in particular directly adjoining or resting against the supporting bracket or clamping bracket 24. The joint protrusion 27 has a joint contour 28 with which a joining element 29 of the support bracket 24 engages in a form-fit manner. The illustrated joint is designed in the manner of connecting puzzle parts.

The joint protrusion 27 has a joint opening 30, constructed or formed from the side wall 5a of the busbar 5 or from a fork leg 7a of the fork contact 7, in which a joint pin 31 is accommodated. The joint design allows the elastic forces of the clamping spring 3, braced in the busbar 5 between its bar sections or walls 5b, 5c, to be absorbed while maintaining the dimensional stability of the busbar 5. In addition, consistent positioning and/or uniform contact forces in the fork contact 7 may be ensured.

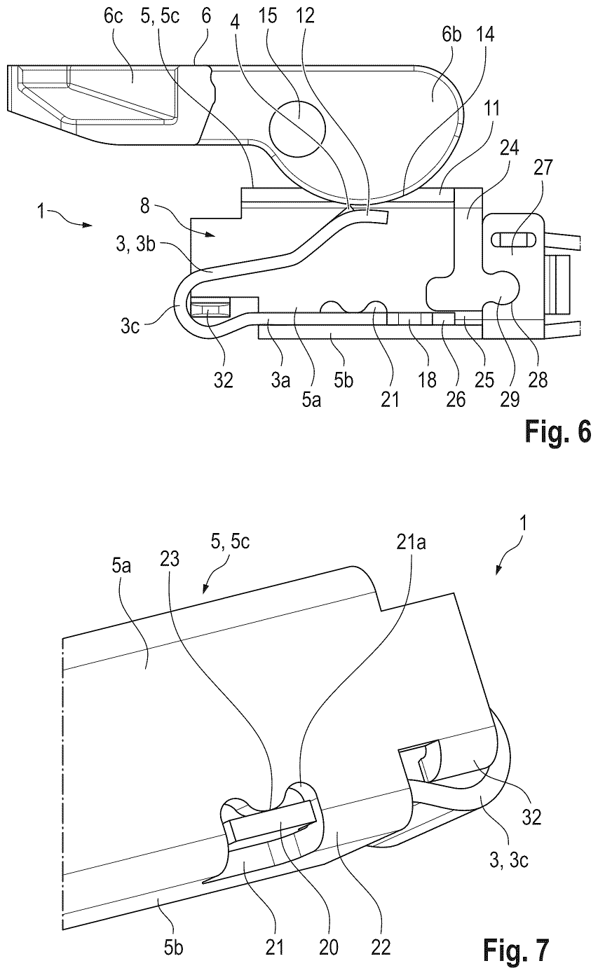

As is apparent in particular from FIGS. 6, 7, and 10, a positioning protrusion 32 is integrally formed on the busbar 5 or at its side wall 5a in the area of the (conductor) insertion opening 9. This positioning protrusion protrudes into the spring bend 3c of the clamping spring 3, preferably with abutment against the spring bend 3c and/or the contact leg 3a. Advantageous position fixing or spring positioning of the clamping spring 3 within the conductor connection channel 8 or in the busbar 5 is achieved in this way.

FIG. 12 illustrates the electrical connection terminal 1, with the fork contact 7 that is integrally formed on the busbar 5 at its end opposite from the insertion opening 9, together with mutually inclined contact legs or fork legs (tulip legs) 7a, 7b. These contact legs are oriented along the insertion direction E and form a contact point 33, for example for a contact pin. For this purpose, the contact legs 7a, 7b in the area of their movable leg free ends have mutually facing indentations/curvatures 34 that are formed by bead-like embossments.

FIG. 13 illustrates a housing 35 of a series arrangement of electrical connection terminals with swivel or actuation levers 6 that are pivotably supported on the housing side. FIGS. 14 and 15 illustrate variants of a detent connection of housing parts 36, 37 of a two-part clamping housing 35 to the busbar 5 of the electrical connection terminal 1.

The housing 35 has a number of (conductor) insertion channels 38 corresponding to the number of connection terminals arranged in series. Of these, only one insertion channel 38 of a first housing part 26 is denoted in detail. The first housing part 36 of the clamping housing 35 has a side wall 36a that circumferentially closes the conductor connection channel 8, or replaces or forms the missing side wall of the busbar 5. The clamping housing 35, in particular its first housing part 36, has a free area 36b for the actuating element 6. The eccentric section 6b of the actuating element 6 passes through the free area 36b and immerges into the conductor connection channel 8.

The housing parts 36, 37 have joining elements 39 or detent contours 40 that correspond to the busbar 5. In the design according to FIG. 14, a first housing part 36 that accommodates the busbar 5, with the clamping spring 3 already situated therein, has a housing-side joining element 39a in the form of a locking hook that engages with a bar-side detent contour (cutaway) 40a of the abutment wall 5b of the busbar 5. A second housing part 37 that accommodates the fork contact 7 likewise has a joining element 39b which is designed as a locking hook and which engages with a detent contour (cutaway) 40b of the contact wall 5c of the busbar 5.

In the design according to FIG. 15, a first housing part 36 that accommodates the busbar 5, with the clamping spring 3 already situated therein, has a housing-side detent contour 41a in the form of a detent recess with which a bar-side joining element 42a, in the form of a pawl that is formed from the abutment wall 5b of the busbar 5, engages. A second housing part 37 that accommodates the fork contact 7 has a housing-side detent contour 41b in the form of a detent recess with which a bar-side joining element 42b, in the form of a pawl that is formed from the contact wall 5c of the busbar 5, engages.

The entry channel 38 of the clamping housing 35 or its first housing part 36 which opens into the conductor insertion channel 8 is funnel-shaped or conically tapers toward the conductor connection channel.8. In a channel area or section 43 of the entry channel 38 that opens into the conductor insertion channel 8, a recess or cavity 44 in which the spring bend 3c of the clamping spring 3 lies is provided in the clamping housing 35 or in the first housing part 26. The insertion area for the conductor 2, via the entry channel 38 and into the conductor connection channel 8 of the connection terminal 1, is free of edges or other barriers (impact areas), so that the conductor 2 may be guided to the contact point K unhindered.

FIGS. 16A through 16D show variants of the lever 6 with mutually coaxial bearing pins 15 having different axial lengths or various pin diameters. The bearing pin facing or associated with the side wall 5a of the busbar 5 is denoted below by reference numeral 15b, and the bearing pin on the cutaway side, facing or associated with the cutaway 11 of the contact wall 5c of the busbar 5, is denoted below by reference numeral 15a.

In the variants shown in FIGS. 16C and 16D, the bearing pins 15a and 15b have different axial lengths. In the variants shown in FIGS. 16C and 16D, the bearing pins 15a and 15b have various pin diameters. The variants of the levers 6 shown in the figures with bearing pins 15a, 15b having dissimilar designs are particularly suited for a series arrangement with plug connectors, formed from electrical connection terminals 1, in a 2.5-mm grid size.

Via the design of the bearing pins 15a, 15b, an asymmetrical load due to one-sided stress on the lever 6 when the clamping spring 3 is tensioned, in particular with constrained space conditions of the overall structure and/or grid sizes, is counteracted. Due to the differing geometries (length, diameter) of the bearing pins 15a, 15b, they have to absorb the load only at the required locations. In particular, the respective oppositely situated bearing pin 15a, 15b may be smaller or narrower than the bearing pin 15b or 15a subject to heavier loads. This allows a corresponding material savings for bearing pins 15 which in each case are subjected to lower loads.

In summary, the invention relates to an electrical connection terminal 1 that is provided for the clamping contact of an electrical conductor 2 according to a basic design, in which the electrical connection terminal 1 has a busbar 5 with a side wall 5a on which an abutment wall 5b and a contact wall 5c spaced apart therefrom are integrally formed, with formation of a conductor connection channel 8 that is accessible via an insertion opening 9. The connection terminal 1 also has a clamping spring 3 which in particular is braced in the busbar 5, with a contact leg 3a that abuts or rests against the abutment wall 5b of the busbar 5, and with a clamping leg 3b, connected thereto, having a clamping edge 4 that is guided against the contact wall 5c of the busbar 5 with formation of a clamping point K.

The invention further relates to an electrical connection terminal 1 that is provided for the clamping contact of an electrical conductor according to a variant which, in addition to or building on the basic design, has an actuating element 6, in particular a lever, for swiveling the clamping leg 3b against the elastic force of the clamping spring 3 in the direction of its contact leg 3a.

The invention further relates to an electrical connection terminal 1 that is provided for the clamping contact of an electrical conductor according to a variant which, in addition to or building on the basic design, has a connection contact 7 which is provided at the bar end of the busbar 5 opposite from the insertion opening 9, in particular integrally formed on the busbar.

The invention further relates to an electrical connection terminal 1 that is provided for the clamping contact of an electrical conductor according to a variant which, in addition to or building on the basic design, has a two-part clamping housing 35 whose housing parts 36, 37 are preferably latched to the busbar 5.

The invention is not limited to the exemplary embodiments described above. Rather, within the scope of the disclosed claims, other variants of the invention may also be deduced by those skilled in the art without departing from the subject matter of the claimed invention. In particular, within the scope of the disclosed claims, all individual features described in conjunction with the various exemplary embodiments may also be combined in some other way without departing from the subject matter of the claimed invention.

What is claimed is:

1. An electrical connection terminal for a clamping contact of an electrical conductor, the electrical connection terminal, comprising:
a busbar with a side wall on which an abutment wall and a contact wall spaced apart therefrom are integrally formed with formation of a conductor connection channel that is accessible via an insertion opening;
a clamping spring arranged, at least partially, in the conductor connection channel, the clamping spring having a contact leg that is contacted at or rests against the abutment wall of the busbar, the clamping spring having a clamping leg that is connected to the contact leg via a spring bend; and
a clamping edge that is guided against the contact wall of the busbar with formation of a clamping point for clamping contact of the conductor that is guided through the insertion opening and into the conductor connection channel in a conductor insertion direction between the clamping spring and the busbar.

2. The electrical connection terminal according to claim 1, wherein a length of the contact leg of the clamping spring is greater than a length of the clamping leg, and/or wherein the length of the clamping leg of the clamping spring is between 50% and 90%, between 55% and 85%, between 60% and 80%, or is 70±5%, of the length of the contact leg, and/or wherein the clamping leg of the clamping spring, in a position in which the clamping point is open, contacts the contact leg, or a gap or space, is smaller than a diameter, or smaller than one-half the diameter of the spring bend of the clamping spring, and is formed. between the contact leg and the clamping leg.

3. The electrical connection terminal according to claim 1, wherein the side wall in addition to the abutment wall and the contact wall of the busbar form a U shape, and/or wherein a height of the side wall is less than 2.5 times a width of the contact wall, and/or wherein the width of the contact wall of the busbar is between 40% and 60% or 50±5% of the height of the side wall, and/or wherein the width of the abutment wall of the busbar is between 50% and 80% or 70±5% of the height of the side wall.

4. The electrical connection terminal according to claim 1, wherein the spring bend of the clamping spring projects beyond the busbar at an insertion opening of the conductor connection channel, and/or wherein the spring bend of the clamping spring projects beyond the abutment wall and/or the side wall and/or the contact wall at the insertion opening of the conductor connection channel of the busbar, and/or wherein the spring bend of the clamping spring or a curved section of the spring bend that adjoins the contact leg or merges into the contact leg, projects beyond the contact leg at a side opposite from the clamping leg.

5. The electrical connection terminal according to claim 1, wherein the clamping leg of the clamping spring has an actuation section that projects beyond the clamping edge in the conductor insertion direction and/or in a transverse direction with respect to the conductor insertion direction.

6. The electrical connection terminal according to claim 5, wherein the actuation section is oriented toward the contact leg of the clamping spring, and/or wherein the actuation section is bent in an arched shape toward the contact leg of the clamping spring.

7. The electrical connection terminal according to claim 1, wherein the contact wall of the busbar has a smaller width than the abutment wall, and/or wherein the width of the contact wall is between 50% and 80% or between 60% and 75% of the width of the abutment wall, and/or wherein the contact wall of the busbar has a cutaway via which the actuation section of the clamping leg of the clamping spring is accessible in a transverse direction with respect to the conductor insertion direction, or in the direction of or substantially perpendicular to the clamping edge.

8. The electrical connection terminal according to claim 1, wherein a recess or a spring cutout is introduced into the contact leg of the clamping spring, and/or wherein a recess or a bar cutout is introduced into the abutment wall of the busbar, and/or wherein a recess or a bar cutout is introduced into the abutment wall of the busbar and is in flush alignment with a recess in the contact leg of the clamping spring, or overlaps completely or at least in part, with same.

9. The electrical connection terminal according to claim 1, wherein a joint protrusion is integrally formed on the contact leg of the clamping spring, and/or wherein a joint opening is provided in the busbar in a bending area or bending section between the side wall and the abutment wall, and/or wherein a joint opening with a constriction that acts locally and/or as a punctiform abutment is provided in the busbar, and/or wherein the joint protrusion of the contact leg of the clamping spring is inserted into the joint opening of the busbar in a form-fit and/or force-fit manner.

10. The electrical connection terminal according to claim 1, wherein a support bracket with a bracket free end directed or guided toward the abutment wall of the busbar is integrally formed on the contact wall of the busbar at the bar end opposite from the insertion opening, wherein, between the support bracket or its bracket free end and the abutment wall of the busbar, a joint gap is formed in which the contact leg of the clamping spring lies at least in areas.

11. The electrical connection terminal according to claim 1, wherein a joint protrusion that is directed or guided toward the abutment wall of the busbar is integrally formed on the contact wall of the busbar at a bar end opposite from the insertion opening.

12. The electrical connection terminal according to claim 11, wherein the joint protrusion has a joint contour that corresponds to a joining element of the support bracket with establishment of a form fit or a form-fit connection, and/or wherein the joint protrusion has a joint contour with which a joining element of the support bracket engages in a form-fit manner, and/or wherein the joint protrusion has a joint opening which accommodates a joint pin that is constructed or formed from the side wall at the bar end of the busbar opposite from the insertion opening, or wherein the joint protrusion has a joint opening which accommodates a joint pin that is formed from a connection contact or a fork contact or fork contact leg that is provided at the busbar or integrally formed thereon at the bar end opposite from the insertion opening.

13. The electrical connection terminal according to claim 1, wherein a positioning protrusion which protrudes into the spring bend of the clamping spring, with abutment against the spring bend and/or the contact leg, is integrally formed on the side wall of the busbar in a region of the insertion opening.

14. An electrical connection terminal for the clamping contact of an electrical conductor, the electrical connection terminal comprising:
a busbar with a side wall on which an abutment wall and a contact wall spaced apart therefrom are integrally formed with formation of a conductor connection channel that is accessible via an insertion opening;
a clamping spring that is arranged, at least partially, in the conductor connection channel, with a contact leg that is contacted at or rests against the abutment wall of the busbar, and with a clamping leg that is connected to the contact leg via a spring bend;
a clamping edge is guided against the contact wall of the busbar with formation of a clamping point for clamping contact of the conductor that is inserted through the insertion opening and into the conductor connection channel in a conductor insertion direction between the clamping spring and the busbar; and
an actuator to swivel the clamping leg of the clamping spring in a direction of its contact leg.

15. The electrical connection terminal according to claim 14, wherein the actuator is supported so that it is pivotable about a rotational axis outside the busbar or outside and/or on the wall side of the contact wall opposite from the contact point, and/or wherein the actuator is introducible into the conductor connection channel via a cutaway or at a side of the contact wall of the busbar, and/or wherein the actuator is placeable, with a rounded end-face side, against an actuation section of the clamping leg of the clamping spring that protrudes beyond the clamping edge, and/or is coupleable to the actuation section.

16. The electrical connection terminal according to claim 14, wherein the actuator has a base body with integrally formed bearing pins, one on each side, and/or wherein mutually coaxial bearing pins having different axial lengths and/or various pin diameters are integrally formed on the actuator, and/or wherein the actuator has a centerboard-like eccentric section extending radially with respect to the rotational axis, and/or wherein the actuator has a base body with an axial cutaway with formation of a swivel contour, and/or wherein the actuating element has a lever section extending radially with respect to the rotational axis.

17. An electrical connection terminal for the clamping contact of an electrical conductor, the electrical connection terminal comprising:
a clamping spring; and
an actuator to move the clamping spring,
wherein the actuator has a base body with integrally formed coaxial bearing pins, one on each side, and/or
wherein mutually coaxial bearing pins having different axial lengths and/or various pin diameters are integrally formed on the actuator, and/or
wherein the actuator has a centerboard-like eccentric section extending radially with respect to the rotational axis, and/or
wherein the actuator has a base body with an axial cutaway.

18. An electrical connection terminal for clamping contact of an electrical conductor, the electrical connection terminal comprising:
a busbar with a side wall on which an abutment wall and a contact wall spaced apart therefrom are integrally formed with formation of a conductor connection channel that is accessible via an insertion opening;
a clamping spring that is arranged, at least partially, in the conductor connection channel, with a contact leg that is contacted at or rests against the abutment wall (of the busbar, and with a clamping leg that is connected to the contact leg via a spring bend;
a clamping edge that is guided against the contact wall of the busbar with formation of a clamping point for clamping contact of the conductor that is inserted through the insertion opening and into the conductor connection channel in a conductor insertion direction between the clamping spring and the busbar; and
a connection contact which is provided at the bar end of the busbar opposite from the insertion opening or integrally formed on the busbar, or a fork contact with contact legs which are oriented in the insertion direction and which form a contact point.

19. An electrical connection terminal for a clamping contact of an electrical conductor, the electrical connection terminal comprising:
a busbar with a side wall on which an abutment wall and a contact wall spaced apart therefrom are integrally formed with formation of a conductor connection channel that is accessible via an insertion opening;
a clamping spring that is arranged, at least partially, in the conductor connection channel, with a contact leg that is contacted at or rests against the abutment wall of the busbar, and with a clamping leg that is connected to the contact leg via a spring bend;
a clamping edge that is guided against the contact wall of the busbar with formation of a clamping point for clamping contact of the conductor that is inserted through the insertion opening and into the conductor connection channel in a conductor insertion direction, between the clamping spring and the busbar; and
a two-part clamping housing whose housing parts are joined or locked to the busbar.

20. The electrical connection terminal according to claim 19, wherein the housing parts have joining elements or detent contours that correspond to the busbar, and/or wherein a first housing part that accommodates the busbar and the clamping spring has a first joining element or a first detent contour, and the abutment wall of the busbar has a corresponding detent contour or a corresponding joining element, and/or wherein a second housing part, for accommodating a connection contact, has a first joining element or a first detent contour, and the contact wall of the busbar has a corresponding detent contour or a corresponding joining element.

21. The electrical connection terminal according to claim 19, wherein in an area opposite from the side wall of the busbar, the conductor connection channel is closed by f a side wall of the clamping housing or its first housing part, and/or wherein the clamping housing or its first housing part has a free area, and an actuating element, or its eccentric section, passes through this free area to actuate the clamping spring or the actuating element or its eccentric section, immerges into the free area, and/or wherein an actuator actuates the clamping spring or its clamping leg only in an area opposite from the side wall of the busbar, and/or wherein a side wall of the clamping housing and an actuator or an eccentric section, form a channel wall that circumferentially closes the conductor connection channel, and/or wherein a side wall of the clamping housing and the actuator are in flush alignment with the side wall or an eccentric section is in flush alignment with the side wall, and form a channel wall that circumferentially closes the conductor connection channel, and/or wherein the clamping housing or its first housing part has a funnel-shaped entry channel for the conductor, and/or wherein the clamping housing or its first housing part has a conical entry channel for the conductor which opens into the conductor insertion channel, and/or wherein a recess on the housing side for the or a spring bend of the clamping spring is provided in a channel area of an entry channel of the clamping housing that opens into the conductor insertion channel.
